(19) United States
(12) Patent Application Publication
(10) Pub. No.: US 2007/0290514 A1
(43) Pub. Date: Dec. 20, 2007

(54) Adjustable deadbolt backset latch

(76) Inventor: Jason M. Halac, Lake Forest, CA (US)

Correspondence Address: Richard J. Veltman, Esq.;The Black & Decker Corporation, 701 East Joppa Road TW199, Towson, MD, 21286, US

(21) Appl. No.: 11/447,185

(22) Filed: Jun. 5, 2006

(51) Int. Cl. E05B 9/00

(52) U.S. Cl. 292/337

(57) ABSTRACT

An adjustable-backset deadbolt lock with a dual-adjustment capability including a simple push-and-twist operation to adjust the relief of the outer casing, as well as a second adjustment capability for adjusting the deadbolt travel. The deadbolt lock generally comprises a latch case defined by opposing walls having an aperture there through, and a guide tab projecting forwardly from the latch case. An annular frontal casing is inserted onto the latch case and receives the guide tab in a track. The frontal casing remains rotatable on the latch case, the track engaging the guide tab during rotation to extend or retract the frontal casing. The track includes two stop positions so that the frontal casing may be adjusted by an indexed push-and-twist adjustment between two positions relative to the latch case as indexed by the stop positions. The lock also includes a deadbolt with adjustable travel via a two-part bolt cam that is turned to extend/retract the bolt extension and deadbolt. The dual-adjustment effectively transforms a backset 2⅜″ (60 mm) into one of backset 2¾″ (70 mm), or vice versa, by two simple push-and-twist operations: one to the outer casing and one to the deadbolt.

### BACKGROUND OF THE INVENTION

1. Field of the Invention

The present invention relates to deadbolt locks, and more particularly to an adjustable deadbolt lock mechanism with convenient push-and-twist adjustment for either a 2⅜ or 2¾ inch extension as desired for residential and commercial buildings.

2. Description of the Background

In most typical deadbolt locks, a crank actuates a bolt which extends into/out from a strike plate on a door frame. The crank may be equipped with either a thumb-knob or lock cylinder for operating the bolt. The axis of the crank intersects the sliding bolt orthogonally, typically at a standard “backset” of two and three-eighths inch from an edge of the door. Under motion of the crank the bolt is selectively engaged and disengaged from the strike plate. Unfortunately, both the length of the bolt and the length of its stroke is usually set (the stroke typically being limited to about one inch).

Adjustable backset door latches have been developed which utilize various mechanisms to vary the distance between the door edge and the rotational axis of the latch knob. Adjustable backset door latches have included slot and pin arrangements such as shown and described in U.S. Pat. Nos. 1,661,454 and 4,372,594, and spring-loaded pins such as shown and described in U.S. Pat. Nos. 4,653,787 and 4,602,490. Unfortunately, these devices are either unduly complex or suffer fro installation problems, such as difficulty in setting the backset distance.

It would be greatly advantageous to provide an easier configuration for adjusting the backset by use of a simple push-and-twist indexing feature to facilitate the two required backset adjustment positions. The backset deadbolt described herein is also particularly advantageous in that it has a minimum number of internal components making it economical to produce and more reliable in operation

### SUMMARY OF THE INVENTION

It is, therefore, the primary object of the present invention to provide an improved adjustable-backset deadbolt lock which can transform a backset 2⅜″ (60 mm) into one of backset 2¾″ (70 mm) by simple push-and-twist operation on the outer casing.

It is another object to provide an improved adjustable-backset deadbolt lock as described above that accomplishes the above transformation by push-and-twist operation that adjusts the relief of the outer casing.

It is another object to provide an improved adjustable-backset deadbolt lock as above which, in addition to the above-described adjustment capability for relief of the outer casing, adds a second adjustment capability for adjusting the deadbolt travel.

It is another object to provide an improved adjustable-backset deadbolt lock with dual-adjustments as described above, both adjustments being convenient push-and-twist operations, one for indexed adjustment of the outer casing and one for indexed adjustment of the deadbolt travel.

In accordance with the foregoing objects, the present invention is an adjustable-backset deadbolt lock with a dual-adjustment capability including a first adjustment comprising a simple push-and-twist operation to adjust the relief of the outer casing, as well as a second adjustment capability for adjusting the deadbolt travel. The deadbolt lock generally comprises a latch case defined by opposing walls having an aperture there through, and a guide tab projecting forwardly from the latch case. An annular frontal casing is inserted onto the latch case and receives its frontal guide tab in a track. The frontal casing remains rotatable on the latch case, the track engaging the guide tab during rotation to extend or retract the frontal casing. The track includes two stop positions so that the frontal casing may be adjusted by an indexed push-and-twist adjustment between two positions relative to the latch case as indexed by the stop positions. The lock also includes a deadbolt with adjustable travel. This is accomplished by a two-part bolt including a tubular deadbolt seated in the annular frontal casing for extension/retraction there from, and a bolt extension length-adjustably engaged to the deadbolt. The bolt extension extends a cam follower into the latch case. A cam is rotatably seated in the aperture of the latch case and extends a lever that engages the cam follower such that rotation of the cam (by key or knob) extends/retracts the bolt extension and deadbolt. The dual-adjustment of both the frontal casing relative to the latch case and the travel of the deadbolt effectively transforms a backset 2⅜″ (60 mm) into one of backset 2¾″ (70 mm), or vice versa, by two simple push-and-twist operations: one to the outer casing and one to the deadbolt.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a perspective view of the adjustable deadbolt backset latch 2 according to a preferred embodiment of the invention.

FIG. 2 is an exploded diagram of the adjustable deadbolt backset latch 2 as in FIG. 1.

FIG. 3 is an exploded perspective view of the length-adjustable deadbolt 10 with bolt extension 12 as in FIG. 2.

FIG. 4 is a top view of the assembled length-adjustable deadbolt 10 and bolt extension 12 as in FIGS. 2-3.

FIG. 5 is a side cross-section of the assembled length-adjustable deadbolt 10 and bolt extension 12 as in FIGS. 2-4.

FIG. 6 is a front view of the bolt extension 12.

FIG. 7 is a side view of the bolt extension 12 of FIG. 6.

FIG. 8 is a side view of the right latch case 30.

FIG. 9 is a top view of the right latch case 30 as in FIG. 8.

FIG. 10 is a section view along A-A of FIG. 8.

FIG. 11 is a section view along C-C of FIG. 8.

FIG. 12 is a perspective view of the left latch case 20.

FIG. 13 is a side view of the left latch case 20 of FIG. 12.

FIG. 14 is a top view of the left latch case 20 of FIGS. 12-13.

FIG. 15 is an end view of the left latch case 20 of FIGS. 12-14.

FIG. 16 is a perspective view of the frontal casing 40.

FIG. 17 is a side cross-section of the frontal casing 40 of FIG. 16.

FIG. 18 is a rotated side view of the frontal casing 40 of FIGS. 16-17.

FIG. 19 is an end view of the frontal casing 40 of FIGS. 16-18.

FIG. 20 is a section view along F-F of FIG. 19.

FIG. 21 is a section view along E-E of FIG. 18.

### DETAILED DESCRIPTION OF THE PREFERRED EMBODIMENTS

The present invention is an adjustable deadbolt backset latch with an adjustable-backset deadbolt lock with adjustable outer casing allowing indexed adjustment of the relief of the outer casing by simple push-and-twist operation and, additionally, a second adjustment for the deadbolt travel allowing push-and-twist indexed adjustment thereof, the dual adjustment capability allowing transformation of a backset of 2⅜″ (60 mm) into one of backset 2¾″ (70 mm).

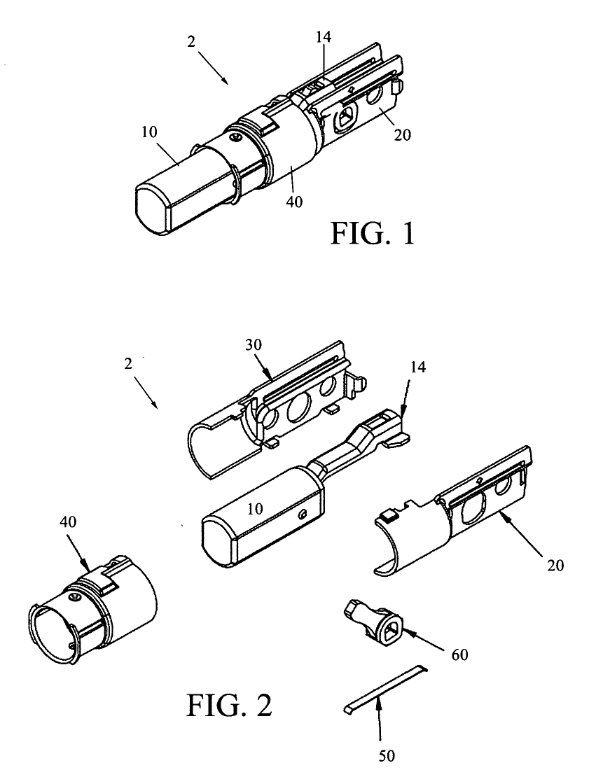

FIG. 1 is a perspective view of the adjustable deadbolt backset latch 2 according to one embodiment of the invention, and FIG. 2 is an exploded diagram of the adjustable deadbolt backset latch 2 as in FIG. 1. The adjustable deadbolt backset latch 2 generally comprises a deadbolt 10 with bolt extension 12, a left latch case 20, a right latch case 30, annular frontal casing 40, and an internal cam 60 and flat bias spring 50 for indexed adjustment of the cam 60. The cam 60 is rotated by an external key lock or thumb knob (not shown) and engages bolt extension 12 to extend or retract the deadbolt 10 into/from a strike plate mounted opposite the door on a door frame. The left latch case 20 and right latch case 30 fit together about the deadbolt 10 and bolt extension 12, which is slidably supported interiorly of the combined left and right latch cases 20, 30. The annular frontal casing 40 fits over the distal end of the combined left and right latch cases 20, 30 to help to secure them together, leaving a central aperture 42 to allow free ingress and egress of the deadbolt 10. The frontal casing 40 is adjustable by convenient push-and-twist adjustment relative to the combined left and right latch cases 20, 30. In addition, the deadbolt 10 includes an interior push-and-twist length adjustment mechanism (as will be described) that allows axial adjustment of the effective length of the deadbolt 10. The combined adjustments facilitate easy installation at either a 2⅜ or 2¾ position as desired.

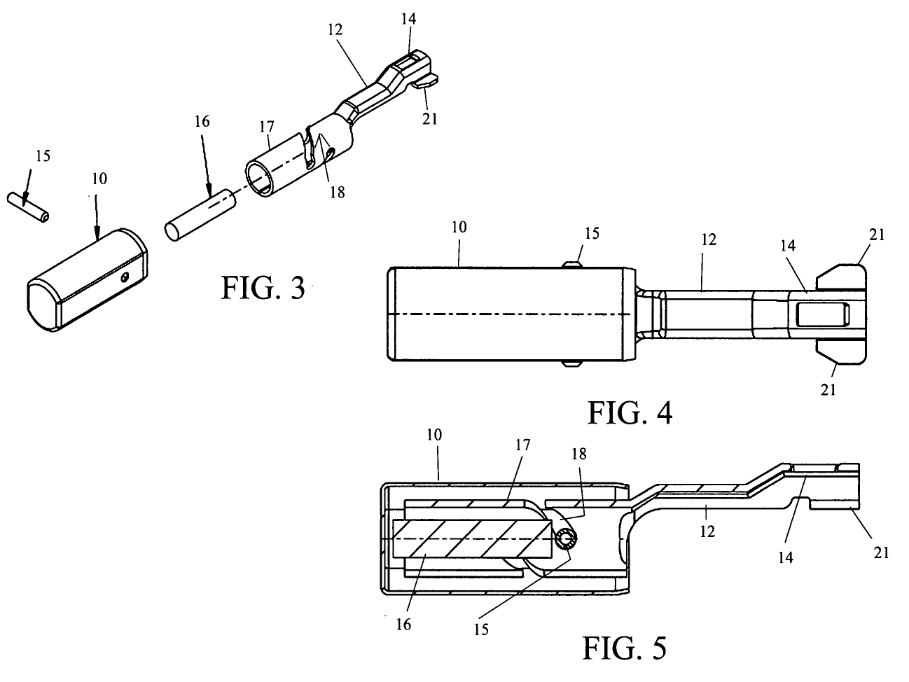

FIG. 3 is an exploded perspective view of the length-adjustable deadbolt 10 with bolt extension 12, FIG. 4 is a top view of the assembled length-adjustable deadbolt 10 and bolt extension 12, and FIG. 5 is a side cross-section thereof. With combined reference to FIGS. 3-5, the deadbolt 10 itself is a tubular member in the shape of a conventional deadbolt, closed at front and open at rear, with a lateral aperture 11 there through toward the open-ended rear of the deadbolt 10 for seating of a transverse compression pin 15. The bolt extension 12 comprises a hollow tubular ferrule 17 defined by a helical adjustment notch 18, the tubular ferrule 17 being integrally joined to a rearwardly-projecting detent arm 19 that bears a cam follower 14 with opposing guide tabs 21. A security pin 16 is loaded into the hollow of the deadbolt 10, the hollow tubular ferrule 17 of the bolt extension 12 is inserted into the hollow of the deadbolt 10, and the compression pin 15 is inserted through the ferrule 17 of the bolt extension 12 and the helical adjustment notch 18. Thus, the helical adjustment notch 18 rides on the compression pin 15, thereby allowing push-and-twist length adjustment of the deadbolt 10 relative to the bolt extension 12, effectively allowing axial adjustment of the effective length of the deadbolt 10. The compression pin 15 may be a conventional compression spring carried on a supporting member. The security pin 16 comprises a short ferrule of rolled steel that occupies the hollow of the deadbolt 10 as a security measure. Should an intruder attempt to saw through the deadbolt 10, the saw will eventually encounter the security pin 16, and security pin 16 will roll. By rolling with the saw blade, security pin 16 effectively prevents further cutting and thwarts the intrusion. The helical adjustment notch 18 in the forward ferrule 17 of the bolt extension 12 preferably comprises a 180 degree annular notch encircling the forward ferrule 17 of the bolt extension 12 with two opposing stop positions offset by approximately ⅜ inches. The adjustment notch 18 acts as a worm gear guided by the compression pin 15 to set the axial position of the bolt 10 forward or backward (relative to the bolt extension 12) by ⅜ inches upon 180 degree clockwise/counterclockwise twisting of the bolt 10, thereby providing convenient axial backset adjustment of the effective length of the deadbolt 10 to either a 2⅜ or 2¾ position as desired, by manual push-and-twist operation. Backset adjustment is accomplished by first placing deadbolt 10 in its extended position (FIG. 1). In its extended position, deadbolt 10 is sufficiently forward to permit it to be twisted, permitting bolt 10 to be movable axially to either 2⅜ or the 2¾ position as desired.

As mentioned above, the bolt extension 12 protrudes rearwardly from the forward ferrule 17 to a cam follower 14 that can be selectively engaged by operation of the cam 60 to effect both forward and rearward motion of the deadbolt 10.

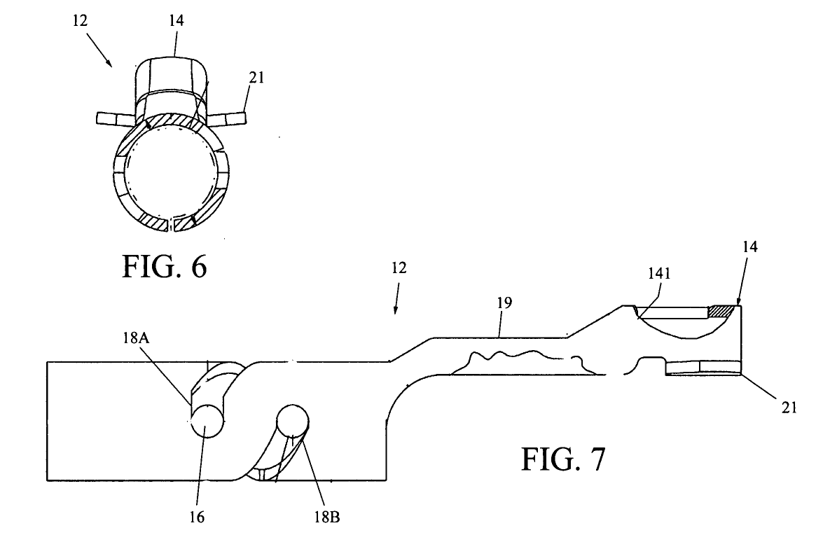

FIG. 6 is a front view, and FIG. 7 a side view of the bolt extension 12 which, at the front end, comprises the press-formed tubular ferrule 17 most conveniently made from a flat metal blank die-cut initially to form the notch 18 and, when rolled around, defines the helical adjustment notch 18 (the tubular ferrule 17 being integrally joined to the rearwardly-projecting detent arm 19 which also bears the cam follower 14 with opposing guide tabs 21 as shown). As seen in FIG. 7, the helical adjustment notch 18 in the completed form comprises a 180 degree annular notch encircling the ferrule 17, and angling sharply to a forward vertical stop position 18A. A rearward stop position 18B need not be angled as the compression pin 15 naturally stops in this position. The forward and rearward stop positions 18A, 18B are preferably offset by approximately ⅜ linear inches to provide forward or backward adjustment of the deadbolt 10 by ⅜ inches upon 180 degree clockwise/counterclockwise twisting of the bolt 10, this corresponding to either a 2⅜ or 2¾ backset position as desired. The tubular ferrule 17 is integrally joined to the rearwardly-projecting detent arm 19 which extends to the distal cam follower 14. The cam follower 14 is formed as a bounded open-bottom enclosure defined by an upwardly-directed window 141, and is formed with opposing laterally-protruding guide tabs 21. The guide tabs are slidably received on elongate tracks formed in the left latch case 20 and right latch case 30 (as will be described) for guided and length-limited movement there along. The entire detent arm 19 inclusive of the distal cam follower 14 may be cut from the same flat blank as the ferrule 17, the cut portion then being press-formed to define the bounded open-bottom enclosure with upwardly-directed window 141, and laterally-protruding guide tabs 21.

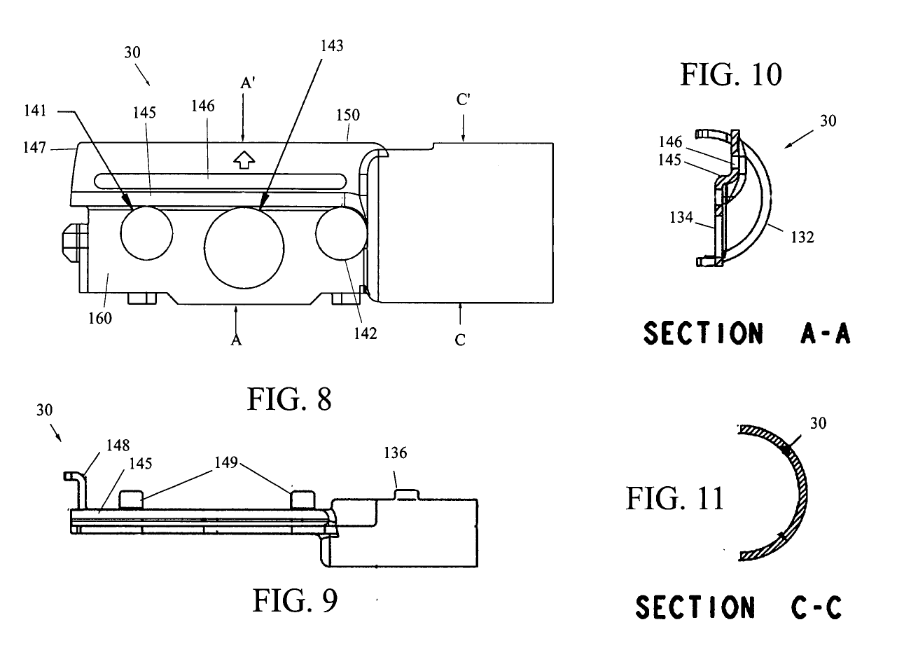

Turning to FIGS. 8-11, the right latch case 30 is show in the context of a side view (FIG. 8), top view (FIG. 9), first section view (FIG. 10 along A-A′ of FIG. 8), and second section view (FIG. 11 along C-C′ of FIG. 8), respectively. The right latch case 30 generally comprises a semi-cylindrical section 132 integrally joined to a flat section 134. The semi-cylindrical section 132 protrudes forward to provide a half-enclosure for the sliding deadbolt 10. One or more tabs 136 may be provided along the lip of the semi-cylindrical section 132 for locking engagement with the left latch case 20. Flat section 134 is defined by a lower wall 160 running up to a laterally-protruding ridge which serves as a track 145 for the guide tab 21 of bolt extension 12. The track 145 segregates the lower wall 160 from an upper wall 150, and the upper wall 150 is defined by an elongate slot 146 running there across for capturing the distal end of the guide tab 21 of bolt extension 12. The lower wall 160 is further defined by a series of apertures including opposing circular apertures 141, 142 for insertion of securing bolts (not shown) to anchor the assembly inside the door, and an intermediate aperture 143 for pivotally mounting the cam 60. Flat section 134 is also formed with structural features for attachment to the left latch case 20, which in the illustrated embodiment includes a post 148 with distally-angled tab protruding from the lower wall 160 of flat section 134 and adapted for engaging a slot in the left latch case 20. In this regard, the right latch case 30 may be fixedly attached to the left latch case 20. A pair of tabs 149 protrude from the bottom lip of the lower wall 160 of flat section 134 for seating the bias spring 50 for indexed adjustment of the cam 60.

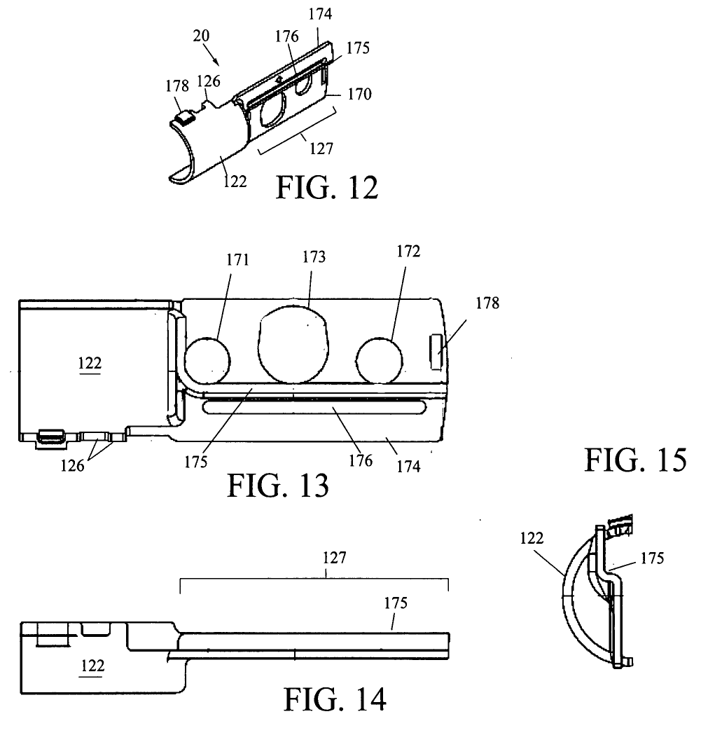

FIGS. 12-15 illustrate the left latch case 20 in the context of a perspective view (FIG. 12), inverted side view (FIG. 13), top view (FIG. 14), and end view (FIG. 15). The left latch case 20 generally comprises a semi-cylindrical section 122 integrally joined to a flat section 124. The semi-cylindrical section 122 protrudes forward to provide a half-enclosure for the sliding deadbolt 10. One or more tabs 126 may be provided along the lip of the semi-cylindrical section 122 for locking engagement with the right latch case 30. Flat section 124 is defined by a lower wall 170 running up to a laterally-protruding ridge which serves as a track 175 for the guide tab 21 of bolt extension 12. The track 175 segregates the lower wall 170 from an upper wall 174, and the upper wall 174 is defined by an elongate slot 176 running there across for capturing the distal end of the guide tab 21 of bolt extension 12. The lower wall 170 is further defined by a series of apertures including opposing circular apertures 171, 172 for insertion of securing bolts (not shown) to anchor the assembly inside the door, and an intermediate aperture 173 for seating the cam 60. Flat section 124 is also formed with structural features for attachment to the right latch case 30, which in the illustrated embodiment include a notch 178 for receiving post 148. In addition, an upwardly protruding guide tab 178 is defined at the forefront of the semi-cylindrical section 122 for engagement with the frontal casing 40 as will be described.

Referring back to FIG. 2, the cam 60 includes a keyed hub pivotally mounted between the right latch case 30 and left latch case 20 seated in the two intermediate apertures 143, 173. A lever extends outward from the hub and engages the cam follower 14 of the rearwardly-projecting detent arm 19. Thus, rotation of the cam 60 via an external keylock or thumb-knob drives the cam follower 14, the detent arm 19, and consequently the deadbolt 10. The spring 50 is a flat resilient member formed of spring steel or the like, and with down-turned distal ends. The ends of the spring 50 wrap around the pair of tabs 149 protruding from the bottom lip of the lower wall 160 of flat section 134, thereby seating the bias spring 50 in direct contact against the bottom of the cam 60 hub for indexed adjustment of the cam 60. In this regard, the periphery of the cam 60 hub is preferably defined by flattened areas to index the cam 60, and hence the deadbolt 10 into fully extended and retracted positions.

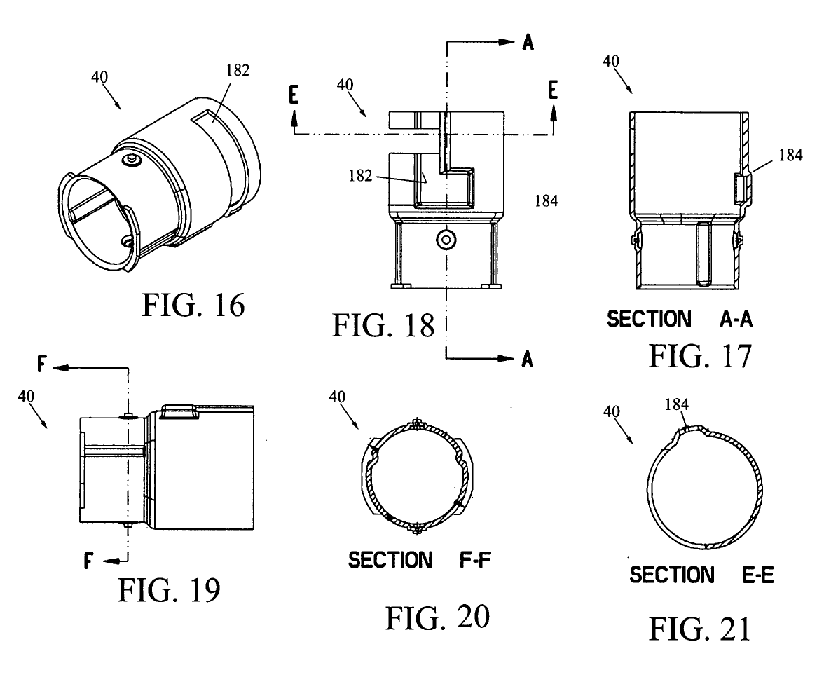

FIGS. 16-21 illustrate the frontal casing 40 in the context of a perspective view (FIG. 16), side cross-section (FIG. 17), rotated side view (FIG. 18), end view (FIG. 19), first section view (FIG. 20 along F-F of FIG. 19), and second section view (FIG. 21 along E-E of FIG. 18). The frontal casing 40 generally comprises a cylindrical section dimensioned to slidably receive the joined forefront of the combined right latch case 30 and left latch case 20. An annular slot 182 partially encircles the frontal casing 40 and runs to an angled guide track 184, the latter being formed as an outward indentation in the frontal casing 40. The combined slot 182 and guide track 184 slidably receive the guide tab 178 of the left latch case 20 for indexed length-adjustment of the frontal casing 40 relative to the right and left latch cases 30, 20. Upon insertion of the frontal casing 40 onto the forefront of the right and left latch cases 30, 20, the guide track 184 enters the guide track 184 at the distal end of the frontal casing 40 and traverses the annular slot 182, continuing past to a right angle recess which serves as a stop position for the guide tab 178 of the left latch case 20. The slot 182 and guide track 184 are preferably offset by approximately ⅜ linear inches to provide forward or backward adjustment of the frontal casing 40 relative to the right and left latch cases 30, 20 by ⅜ inches upon push-and-twist rotation of the frontal casing 40, this corresponding to either a 2⅜ or 2¾ backset position as desired. Thus, the frontal casing 40 is inserted onto the combined right and left latch cases 30, 20 with guide tab 178 entering the guide track 184. By push-and-twist, the frontal casing 40 may be set in position with guide tab 178 resident in the slot 182, or alternately resident in the right angle recess of guide track 184 which likewise serves as a stop position for the guide tab 178. The various unnumbered flanges and pins shown on the frontal exterior of the frontal casing 40 are adapted to interface with various latch plates and mounting collars (not shown) and are not considered to be of significance to the present invention.

In summary of the dual-adjustments described above, both being convenient push-and-twist operations, the first allows for indexed adjustment of the frontal casing 40 relative to the combined right and left latch cases 30, 20, and the second allows for indexed adjustment of the deadbolt 10 effective length. Assuming that the frontal casing 40 is installed, it can be adjusted on the right and left latch cases 30, 20 by push-and-twist with guide tab 178 held captive inside the slot 182, or alternately moving into the right angle recess of guide track 184, both of which define stop positions for the guide tab 178. Likewise, push-and-twist length adjustment of the deadbolt 10 relative to the bolt extension 12 is achieved push-and-twisting the deadbolt 10 on the bolt extension 12, the compression pin 15 riding within the helical notch 18 in the ferrule 17 of bolt extension 12 and driven thereby between stop positions 18A and 18B. The indexed adjustment of the frontal casing 40 plus indexed adjustment of the deadbolt 10 effective length greatly simplify the ability of the adjustable-backset deadbolt lock disclosed herein to transform from a standard backset of 2⅜″ (60 mm) into one of backset 2¾″ (70 mm), or vice versa, by simple push-and-twist operation.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept It is to be understood, therefore, that the invention may be practiced otherwise than as specifically set forth in the appended claims.

I claim:

1. A deadbolt lock, comprising:
a deadbolt defined as a hollow tubular member closed at one end, open at another end, and having a transverse hole there through proximate the open end of the deadbolt;
a bolt extension, including,
a frontal portion defined as a tubular member adapted for insertion into the open end of said deadbolt, and having a helical adjustment notch encircling the tubular member, and
a cam-follower attached to said frontal portion for protruding outward from said deadbolt;
a pin seated in the transverse aperture of said deadbolt and passing through the helical adjustment notch of said bolt extension for guiding relative telescoping extension of said deadbolt upon rotation thereof, thereby adjusting travel of said deadbolt;
a latch case;
a cam pivotally mounted in said latch case and operatively engaged to the cam follower of said bolt extension;
whereby rotation of said cam drives the cam follower.

2. The deadbolt lock according to claim 1, wherein the cam pivotally mounted in said latch case comprises a lever arm joined to a hub, said hub being pivotally mounted in said latch case.

3. The deadbolt lock according to claim 2, wherein the hub of said cam is defined by at least one peripherally flattened area to index rotation of said cam, and consequently extension of said deadbolt.

4. The deadbolt lock according to claim 1, further comprising a rotatable security pin seated in the hollow of said bolt extension for spinning when encountered by a saw.

5. The deadbolt lock according to claim 1, wherein the helical adjustment notch of said bolt extension allows push-and-twist indexed adjustment between a backset of 2⅜″ (60 mm) into one of backset 2¾″ (70 mm).

6. The deadbolt lock according to claim 1, wherein said latch case comprises a pair of opposing walls both defined by an elongate track, said cam follower being seated on said track and slidable there along.

7. The deadbolt lock according to claim 6, wherein said latch case comprises a pair of opposing walls both defined by an elongate track and a notch running parallel to said track, said cam follower being seated on said track and including laterally protruding tabs received in the notches of the latch case walls.

8. The deadbolt lock according to claim 1, wherein said latch case comprises a pair of opposing walls both defined by an aperture for seating said cam, and at least one lateral strut beneath said apertures joining said opposing walls together and providing a mounting for a bias spring for imparting a bias against said cam.

9. The deadbolt lock according to claim 8, wherein the hub of said cam is defined by at least one peripherally flattened area for engagement with said bias spring to index rotation of said cam.

10. A deadbolt mechanism for a door comprising:
a latch case defined by opposing walls having an aperture there through, and a guide tab projecting outward from said latch case; and
an annular frontal casing adapted to receive said latch case therein and defined by a track for slidably receiving the guide tab on the latch case for push-and-twist adjustment of said frontal casing on said latch case.

11. The deadbolt mechanism for a door according to claim 10, wherein said track comprises a lengthwise slot along said frontal casing for lengthwise insertion onto said latch case with the guide tab in said slot.

12. The deadbolt mechanism for a door according to claim 11, wherein said track comprises at least two right-angle deviations from the lengthwise slot defining stop positions for the guide tab upon rotation of the frontal casing, thereby indexing positioning of the frontal casing on the latch case.

13. The deadbolt mechanism for a door according to claim 12, wherein said track guides push-and-twist adjustment of the frontal casing on the latch case for transforming a backset of 2⅜″ (60 mm) into one of backset 2¾″ (70 mm) and vice versa.

14. A deadbolt lock, comprising:
a deadbolt defined as a hollow tubular member closed at one end, open at another end, and having a transverse hole there through proximate the open end of the deadbolt;
a bolt extension, including,
a frontal portion defined as a tubular walled member adapted for insertion into the open end of said deadbolt, and having a helical adjustment notch encircling the walls thereof, and
a cam-follower attached to said frontal portion for protruding outward from said deadbolt;
a pin seated in the transverse aperture of said deadbolt and passing through the helical adjustment notch of said bolt extension for guiding relative telescoping extension of said deadbolt upon rotation thereof, thereby adjusting travel of said deadbolt;
a latch case defined by opposing walls having an aperture there through, and a guide tab projecting outward from said latch case;
a cam pivotally mounted in the aperture of said latch case and operatively engaged to the cam follower of said bolt extension, whereby rotation of said cam drives the cam follower; and
an annular frontal casing adapted to receive said latch case therein and defined by a track for slidably receiving the guide tab on the latch case for push-and-twist adjustment of said frontal casing on said latch case.

15. The deadbolt lock according to claim 14, wherein the cam pivotally mounted in said latch case comprises a lever arm joined to a hub, said hub being pivotally mounted in said latch case.

16. The deadbolt lock according to claim 15, further comprising a bias spring mounted in said latch case for basing said cam, the hub of said cam being defined by at least one peripherally flattened area to index rotation of said cam.

17. The deadbolt lock according to claim 14, further comprising a rotatable security pin seated in the hollow of said bolt extension for spinning when encountered by a saw.

18. The deadbolt lock according to claim 14, wherein said latch case comprises a pair of opposing walls both defined by an elongate track, said cam follower being seated on said track and slidable there along.

19. The deadbolt lock according to claim 18, wherein said latch case comprises a pair of opposing walls both defined by an elongate track and a notch running parallel to said track, said cam follower being seated on said track and including laterally protruding tabs received in the notches of the latch case walls.

20. The deadbolt mechanism for a door according to claim 14, wherein said track comprises a lengthwise slot along said frontal casing for lengthwise insertion onto said latch case with the guide tab in said slot.

21. The deadbolt mechanism for a door according to claim 20, wherein said track comprises at least two right-angle deviations from the lengthwise slot defining stop positions for the guide tab upon rotation of the frontal casing, thereby indexing positioning of the frontal casing on the latch case.

22. The deadbolt mechanism for a door according to claim 21, wherein said track guides push-and-twist adjustment of the frontal casing on the latch case, and the helical adjustment notch of said bolt extension allows push-and-twist indexed adjustment, these dual-adjustments collectively transforming a backset of 2⅜″ (60 mm) into one of backset 2¾″ (70 mm) and vice versa.

23. A method of adjusting a backset of a deadbolt lock of a type comprising a hollow tubular deadbolt closed at one end and open at another end, and a bolt extension inserted into the open end of said deadbolt, said bolt extension being defined by a radial adjustment notch and being adjustably secured to said deadbolt by a pin attached to said deadbolt and slidably engaged in said adjustment notch, the method comprising the steps of:
turning said tubular deadbolt relative to said bolt extension to cause said pin to bear against said adjustment notch and telescope said tubular deadbolt relative to said bolt extension for adjusting said backset.

24. The method of adjusting a backset of a deadbolt lock according to claim 23, wherein said step of turning said tubular deadbolt further comprises push-and-twist turning.

25. The method of adjusting a backset of a deadbolt lock according to claim 24, wherein said step of push-and-twist turning further comprises push-and-twist indexed turning.

26. The method of adjusting a backset of a deadbolt lock according to claim 23, wherein said deadbolt lock is of a type comprising a latch case defined by opposing walls having an aperture there through, a guide tab projecting outward from said latch case, and an annular frontal casing adapted to receive said latch case therein and defined by a track for slidably receiving the guide tab on the latch case, and said method further comprises the steps of:
pushing said frontal casing inward onto said latch case, and
turning said frontal casing relative to said latch case such that said track engages said guide tab to telescope said frontal casing relative to said latch case for adjusting said backset.

27. A method of adjusting a backset of a deadbolt lock of a type comprising a latch case defined by opposing walls having an aperture there through, a guide tab projecting outward from said latch case, and an annular frontal casing adapted to receive said latch case therein and defined by a track for slidably receiving the guide tab on the latch case, comprising the steps of:
pushing said frontal casing inward onto said latch case, and
turning said frontal casing relative to said latch case such that said track engages said guide tab to telescope said frontal casing relative to said latch case for adjusting said backset.

28. The method of adjusting a backset of a deadbolt lock according to claim 27, wherein said deadbolt lock is of a type comprising a hollow tubular deadbolt closed at one end and open at another end, and a bolt extension inserted into the open end of said deadbolt, said bolt extension being defined by a radial adjustment notch and being adjustably secured to said deadbolt by a pin attached to said deadbolt and slidably engaged in said adjustment notch, and said method further comprises the steps of:
turning said tubular deadbolt relative to said bolt extension to cause said pin to bear against said adjustment notch and telescope said tubular deadbolt relative to said bolt extension for adjusting said backset.

29. The deadbolt mechanism for a door according to claim 28, wherein said steps of pushing said frontal casing inward, turning said frontal casing relative to said latch case, and turning said tubular deadbolt relative to said bolt extension adjusts transforms a backset of 2⅜″ (60 mm) into one of backset 2¾″ (70 mm) and vice versa.
